(19) United States
(12) Patent Application Publication
(10) Pub. No.: US 2024/0079621 A1
(43) Pub. Date: Mar. 7, 2024

(54) MEMBRANE-ELECTRODE ASSEMBLY CAPABLE OF PREVENTING LEAK OF ANTIOXIDANT

(71) Applicants: HYUNDAI MOTOR COMPANY, SEOUL (KR); KIA CORPORATION, SEOUL (KR)

(72) Inventor: Ju Hee Lee, Yongin-si (KR)

(21) Appl. No.: 18/223,672

(22) Filed: Jul. 19, 2023

(30) Foreign Application Priority Data
Sep. 6, 2022 (KR) 10-2022-0112549

(51) Int. Cl. H01M 8/1004

(52) U.S. Cl. CPC H01M 8/1004

(57) ABSTRACT

A membrane-electrode assembly is capable of preventing an antioxidant from flowing out from an electrolyte membrane.

### CROSS REFERENCE TO RELATED APPLICATIONS

This application claims under 35 U.S.C. § 119(a) the benefit of priority to Korean Patent Application No. 10-2022-0112549 filed on Sep. 6, 2022, the entire contents of which are incorporated herein by reference.

### BACKGROUND

### a) Technical Field

The present disclosure relates to a membrane-electrode assembly capable of preventing an antioxidant from flowing out from an electrolyte membrane.

### (b) Background Art

The reaction for generating electricity in a fuel cell occurs in a membrane-electrode assembly (MEA) consisting of a perfluorinated sulfonic acid ionomer-based membrane, and electrodes of an anode and a cathode. In order to improve the durability of such a fuel cell, various techniques for mitigating chemical degradation of the electrolyte membrane have been proposed, and for example, a method of adding various types of antioxidants to the electrolyte membrane has been proposed. These antioxidants may include a primary antioxidant having a radical scavenger or quencher function and a secondary antioxidant having a hydrogen peroxide decomposer function which are each used alone or mixed with each other and used.

An electrolyte membrane to which an antioxidant is added in an excessive amount increases the chemical durability, but since the sulfonic acid group in the electrolyte membrane binds to the cationic antioxidant and lowers the hydrophilic properties, the proton conductivity may deteriorate to result in a decrease in cell performance. For this reason, antioxidants need to be appropriately used in consideration of performance and durability. In addition, metal oxides introduced into the electrolyte membrane are dissolved and ionized during the manufacturing process or operation, or an antioxidant directly introduced in the form of ions is lost to the outside of the cell due to their characteristics of easily migrating in the fuel cell driving environment so that the durability of the fuel cell electrolyte membrane may deteriorate in the long term. To this end, it is necessary to develop a functional antioxidant capable of inhibiting the dissolution or migration of the antioxidant or a cell capable of preventing the migration of the antioxidant contained in the electrolyte membrane.

### SUMMARY

An object of the present disclosure is to provide a membrane-electrode assembly capable of preventing an antioxidant in an electrolyte membrane from flowing out during driving of a fuel cell.

Another object of the present disclosure is to provide a configuration which is capable of increasing the durability of the membrane-electrode assembly even with a small amount of the antioxidant by preventing leak of the antioxidant by controlling the surface and structure of the non-reaction part of the electrolyte membrane instead of increasing the content of the antioxidant, such as excessive input of an antioxidant in the electrolyte membrane and input of the antioxidant into the gas diffusion layer.

The objects of the present disclosure are not limited to the objects mentioned above, and other objects of the present disclosure not mentioned may be understood by the following description, and can be seen more clearly by the Examples of the present disclosure. Further, the objects of the present disclosure can be realized by means and combinations thereof described in the claims.

A membrane-electrode assembly according to one embodiment of the present disclosure may include an anode layer, a cathode layer, and an electrolyte membrane which is interposed between the anode layer and the cathode layer and has a sheet shape, wherein the electrolyte membrane may include an antioxidant, the electrolyte membrane may include: a reaction region in which the anode layer and the cathode layer are stacked and located in a central part of the electrolyte membrane; and a non-reaction region that is a rest part except for the reaction region, and the non-reaction region may include a depression part which is formed to be depressed by a predetermined depth in the thickness direction from at least one surface of the electrolyte membrane.

The antioxidant may include ions of a metal element, and the metal element may include at least one selected from the group consisting of cerium, manganese, tungsten, zirconium, titanium, vanadium, yttrium, lanthanum, neodymium, nickel, cobalt, chromium, molybdenum, iron, and combinations thereof.

The depression part may be formed to be depressed in the non-reaction region along a pair of opposite sides of the reaction region.

The reaction region may include a pair of long sides and a pair of short sides, and the pair of sides may include at least one of the pair of long sides and the pair of short sides.

The depth of the depression part may be deepened in a stepwise manner as it goes away from the side end portion of the reaction region.

The depth of the depression part may be inclinedly deepened as it goes away from the side end portion of the reaction region.

The concentration of the antioxidant per unit volume of the non-reaction region may increase as it goes away from the side end portion of the reaction region.

The depth of the depression part may be 10% to 80% of the thickness of the reaction region.

The non-reaction region may include a non-depression part formed at the end of the non-reaction region not to be depressed.

The membrane-electrode assembly may further include a blocking part which is accommodated in the depression part and include a proton donor polymer.

The proton donor polymer may include at least one selected from the group consisting of poly(acrylic acid) (PAA), poly(methacrylic acid) (PMAA), modified polyphenylene oxide (MPPO), and combinations thereof.

The thickness of the blocking part may be thickened as it goes away from the side end portion of the reaction region.

The blocking part may be accommodated in the depression part so that there is no step difference between the reaction region and the non-reaction region.

According to the present disclosure, it is possible to obtain a membrane-electrode assembly in which the antioxidant in the electrolyte membrane does not flow out during driving of the fuel cell.

Further, according to the present disclosure, it is possible to increase the durability of the membrane-electrode assembly even with a small amount of the antioxidant by preventing the outflow of the antioxidant by controlling the surface and structure of the non-reaction part of the electrolyte membrane.

The effects of the present disclosure are not limited to the above-mentioned effects. It should be understood that the effects of the present disclosure include all effects that can be inferred from the following description.

### BRIEF DESCRIPTION OF THE FIGURES

FIG. 1 shows a first embodiment of a membrane-electrode assembly according to the present disclosure.

FIG. 2 shows one form of an electrolyte membrane according to the present disclosure.

FIG. 3 shows another form of the electrolyte membrane according to the present disclosure.

FIG. 4 shows a second embodiment of the membrane-electrode assembly according to the present disclosure.

FIG. 5 shows a third embodiment of the membrane-electrode assembly according to the present disclosure.

FIG. 6 shows a fourth embodiment of the membrane-electrode assembly according to the present disclosure.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals are used for similar elements while explaining each drawing. In the accompanying drawings, the dimensions of the structures are illustrated after being enlarged than the actual dimensions for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part, but also the case where there is another part in the middle therebetween. Conversely, when a part of a layer, film, region, plate, etc. is said to be “under” other part, this includes not only the case where it is “directly under” the other part, but also the case where there is another part in the middle therebetween.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to the maximum value including a maximum value, unless otherwise indicated. Furthermore, when such a range refers to an integer, all integers including from the minimum value to the maximum value including a maximum value are included, unless otherwise indicated.

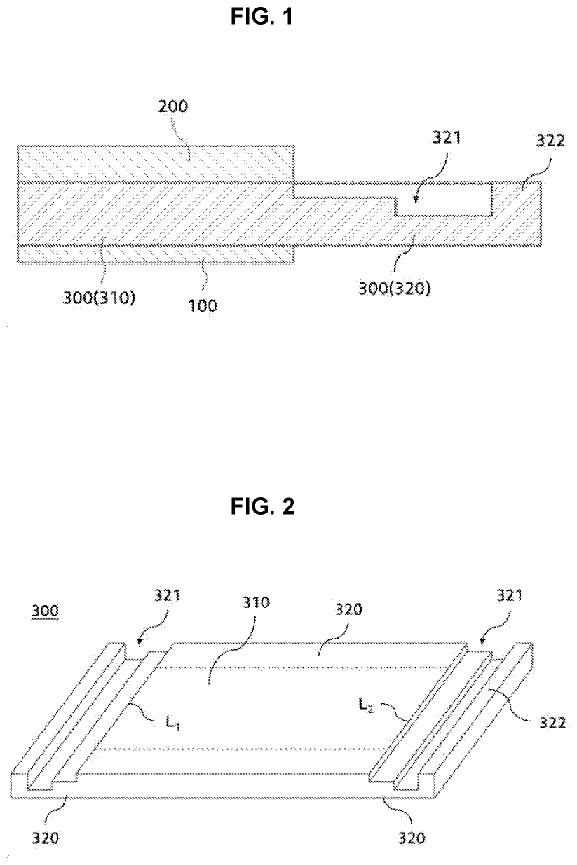

FIG. 1 shows a first embodiment of a membrane-electrode assembly according to the present disclosure. The membrane-electrode assembly may include an anode layer 100, a cathode layer 200, and an electrolyte membrane 300 interposed between the anode layer 100 and the cathode layer 200.

The anode layer 100 and the cathode layer 200 are electrode layers used in a typical membrane-electrode assembly, and may include a platinum catalyst supported on a support, a binder, etc.

The electrolyte membrane 300 may contain a matrix including an ionomer and an antioxidant (not shown) dispersed in the matrix. The electrolyte membrane 300 may have a sheet shape.

The ionomer is not particularly limited, and may include a polymer having cationic conductivity. For example, the ionomer may include a perfluorinated sulfonic acid-based polymer such as Nafion or the like.

The antioxidant may include ions of a metal element.

The metal element may include at least one selected from the group consisting of cerium, manganese, tungsten, zirconium, titanium, vanadium, yttrium, lanthanum, neodymium, nickel, cobalt, chromium, molybdenum, iron, and combinations thereof.

The antioxidant may preferably include trivalent or tetravalent cerium ions.

The antioxidant may further include metal oxides such as cerium oxide (CeO₂) and the like in addition to the ions of the metal element.

The concentration of the antioxidant is not particularly limited, and may be, for example, 2.5 μg/cm² or more, 5 μg/cm² or more, 10 μg/cm² or more, or 20 μg/cm² or more. The concentration of the antioxidant may be 100 μg/cm² or less, 75 μg/cm² or less, or 50 μg/cm² or less. The concentration of the antioxidant may mean a concentration of the antioxidant contained in the electrolyte membrane before driving the fuel cell. In addition, since the electrolyte membrane has an area of a millimeter (mm) to meter (m) scale, whereas it has a thickness of a micrometer (μm) scale, the thickness of the electrolyte membrane has an insignificant effect on the concentration of the antioxidant. Therefore, the concentration of the antioxidant may be based on the area of the electrolyte membrane.

The present disclosure is to prevent the antioxidant from flowing out from the electrolyte membrane 300 to the outside, and the specific means thereof are as follows.

FIG. 2 shows an electrolyte membrane according to the present disclosure. The electrolyte membrane 300 may include a reaction region 310 in which the anode layer 100 and the cathode layer 200 are stacked so as to cause an electrochemical reaction. The reaction region 310 may locate in the central part of the reaction region 310. The electrolyte membrane 300 may include a non-reaction region 320 that is a rest part except for the reaction region 310.

The shape of the reaction region 310 is not particularly limited, but may be a quadrangle including a pair of long sides and a pair of short sides.

The area of the reaction region 310 is not particularly limited and may be appropriately adjusted depending on the specifications of the anode layer 100 and the cathode layer 200, the specifications of the desired membrane-electrode assembly, and the like.

The non-reaction region 320 may include a depression part 321 that is depressed to a predetermined depth in the thickness direction from at least one surface of the electrolyte membrane 300 and a non-depression part 322 that is positioned at an end of the non-reaction region 320 and is not depressed.

The depression part 321 may be depressed along a pair of opposite sides L₁ and L₂ of the reaction region 310. The pair of opposite sides L₁ and L₂ of the reaction region 310 may be appropriately selected depending on the directions of the fuel inlet, fuel outlet, oxygen inlet and oxygen outlet of the membrane-electrode assembly. In addition, the pair of sides L₁ and L₂ may mean a pair of short sides of the reaction region 310, a pair of long sides of the reaction region 310, or both thereof as shown in FIG. 2.

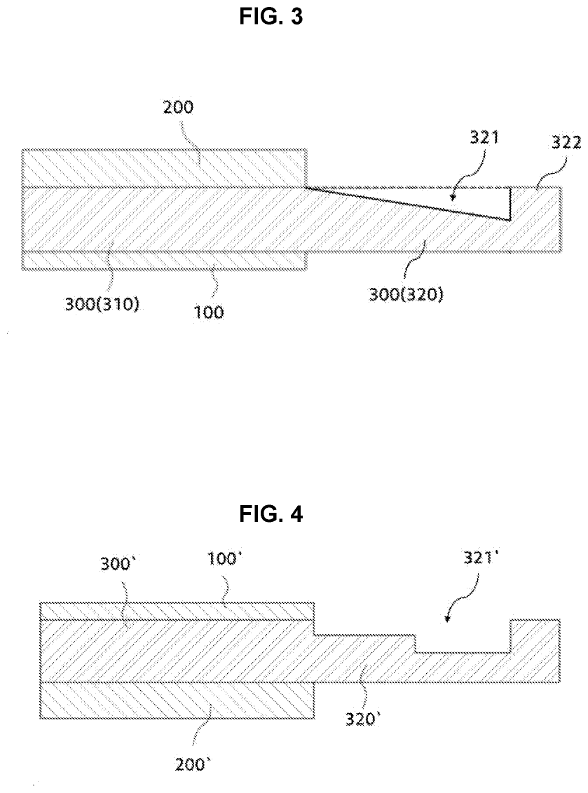

As shown in FIGS. 1 and 2, the depth of the depression part 321 may be deepened in a stepwise manner extending away from the side end portion of the reaction region 310. However, the shape of the depression part 321 is not limited thereto, and the depth of the depression part 321 may be inclinedly deepened extending away from the side end portion of the reaction region 310 as shown in FIG. 3.

Since the depth of the depression part 321 is deepened extending away from the reaction region 310, the concentration of the antioxidant per unit volume of the non-reaction region 320 may increase extending away from the side end portion of the reaction region 310.

In general, the antioxidant in the electrolyte membrane 300 is diffused toward the side end portion of the non-reaction region 320 by the flow of water so that it flows out to the outside.

In the electrolyte membrane 300 according to the present disclosure, since the concentration of the antioxidant per unit volume increases as it goes toward the side end portion within the non-reaction region 320, it is difficult for the antioxidant to diffuse, and the outflow of the antioxidant may be prevented accordingly.

The depth of the depression part 321 may be 10% to 80% of the thickness of the reaction region 310. If the depth of the depression part 321 is less than 10%, since the concentration gradient of the antioxidant per unit volume of the non-reaction region 320 is not sufficient, it may be difficult to prevent the antioxidant from flowing out. If the depth of the depression part 321 exceeds 80%, the durability of the non-reaction region 320 may deteriorate.

FIG. 4 shows a second embodiment of the membrane-electrode assembly according to the present disclosure. In the first embodiment of the membrane-electrode assembly according to FIG. 1, the depression part 321 may be formed on one surface of the electrolyte membrane 300 in contact with the cathode layer 200, and in the second embodiment of the membrane-electrode assembly according to FIG. 4, the depression part 321′ may be depressed on one surface in contact with the anode layer 100′.

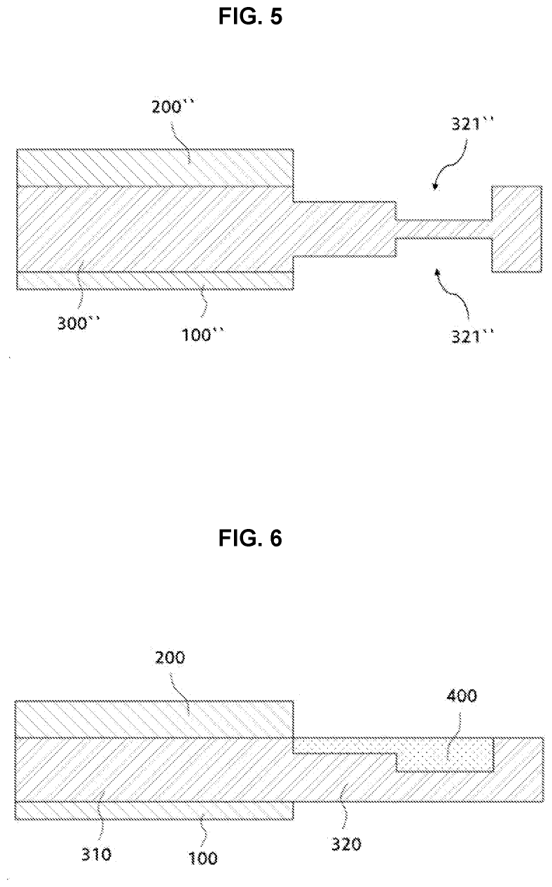

FIG. 5 shows a third embodiment of the membrane-electrode assembly according to the present disclosure. In the third embodiment, the depression part 321″ may be depressed on both surfaces of the electrolyte membrane 300″. In the third embodiment, the depth of the depression part 321″ may mean a value obtained by summing up the depths of each depression part 321″ formed on both surfaces of the electrolyte membrane 300″.

A method for forming the depression part 321 is not particularly limited. After the electrolyte membrane 300 is manufactured in the form of a sheet, the non-reaction region 320 may be thermocompressed. The thermocompression conditions are not particularly limited and may be appropriately adjusted in consideration of the desired depth of the depression part 321, the thickness of the electrolyte membrane 300, and the like. For example, the depression part 321 may be formed by pressurizing the electrolyte membrane 300 to 10 MPa to 50 MPa at 100° C. to 200° C. In addition, the electrolyte membrane 300 including the depression part 321 may be manufactured using molds having shapes of the electrolyte membranes 300 of FIGS. 1, 4, and 5.

FIG. 6 shows a fourth embodiment of the membrane-electrode assembly according to the present disclosure. The membrane-electrode assembly may further include a blocking part 400 accommodated in the depression part 321.

The blocking part 400 may include a proton donor polymer.

The proton donor polymer may include at least one selected from the group consisting of poly(acrylic acid) (PAA), poly(methacrylic acid) (PMAA), modified polyphenylene oxide (MPPO), and combinations thereof.

Since the antioxidant includes metal cations, it has high electron affinity. In general, in order to increase the durability of the membrane-electrode assembly, a sub-gasket (not shown) is attached onto the non-reaction region 320 of the electrolyte membrane 300, and since the sub-gasket contains polyethylene terephthalate (PET), polyethylene naphthalate (PEN), polyimide (PI), polypropylene, and the like that have many electrons, the antioxidant may migrate and flow out in the direction of the non-reaction region 320.

The present disclosure is characterized in that the blocking part 400 made of a proton donor polymer capable of blocking the electron affinity of the antioxidant is put in the depression part 321 to prevent the antioxidant from leaking.

The thickness of the blocking part 400 may be thickened as it extends away from the side end portion of the reaction region 310, and it may be accommodated in the depression part 321 so that the step difference between the reaction region 310 and the non-reaction region 320 is eliminated. Accordingly, when the sub-gasket is attached onto the non-reaction region 320, it is possible to prevent a space between the membrane-electrode assembly and the sub-gasket from being created or adhesion force from being lowered.

The method for forming the blocking part 400 is not particularly limited, and for example, it may be coupled to the depression part 321 after coating the proton donor polymer on the depression part 321 or forming the blocking part 400 in a shape corresponding to the depression part 321.

Hereinafter, another embodiment of the present disclosure will be described in more detail through Examples. The following Examples are merely examples to help the understanding of the present disclosure, and the scope of the present disclosure is not limited thereto.

### Example 1

A electrolyte membrane having a sheet-shape and including an ionomer and an antioxidant was prepared. The ionomer includes Nafion, and the antioxidant includes cerium ions. An anode layer and a cathode layer were stacked on the reaction region of the electrolyte membrane as shown in FIG. 1. The non-reaction region of the electrolyte membrane was thermocompressed to form a depression part as shown in FIG. 2. As it extends away from the side end portion of the reaction region, the depth of the depression part was allowed to be deepened in a stepwise manner, and a total of two stages of depression part were formed as shown in FIGS. 1 and 2.

### Example 2

A blocking part was formed by repeating the process of coating and drying poly(acrylic acid) (PAA) on the depression part of the membrane-electrode assembly according to Example 1 above a total of 5 times.

### COMPARATIVE EXAMPLE

A membrane-electrode assembly was manufactured in the same manner as in Example 1 except that the depression part was not formed.

The migration amounts of the antioxidant in membrane-electrode assemblies according to Example 1, Example 2, and a Comparative Example were analyzed as follows.

The membrane-electrode assemblies according to Example 1, Example 2, and the Comparative Example were each inputted into a container containing 0.1 M hydrochloric acid aqueous solution. Each container containing the membrane-electrode assembly was inputted into a convection oven at about 80° C., and after 30 days, concentrations of cerium ions at certain points in the reaction and non-reaction regions were measured. The results are as shown in Table 1

TABLE 1

| | | | Antioxidant | | Increase or decrease in | |
|---|---|---|---|---|---|---|
| | | | concentration [μg/cm²] | | antioxidant concentration | |
| | Measurement | | Reaction | Non-reaction | Reaction | Non-reaction |
| Classification | time point | | region¹⁾ | region²⁾ | region | region |
| Example 1 | 0 | day | 10.9 | 9.7 | 21.1% | 1.3 times |
| | 30 | day | 8.6 | 12.6 | decrease | increase |
| Example 2 | 0 | day | 10.8 | 9.3 | 15.7% | 1.2 times |
| | 30 | day | 9.1 | 11.5 | decrease | increase |
| Comparative | 0 | day | 10.6 | 9.4 | 51.9% | 1.7 times |
| Example | 30 | day | 5.1 | 15.7 | decrease | increase |

¹⁾The antioxidant concentrations in the reaction region are average values of three points adjacent to the side end portion.
²⁾The antioxidant concentrations in the non-reaction region are average values of five points adjacent to the side end portion.

In Comparative Example, after 30 days, the antioxidant in the reaction region of the electrolyte membrane decreases by 50% or more, and the antioxidant in the non-reaction region thereof increases by 1.7 times. On the other hand, the outflow amount of the antioxidant in the reaction region and the amount of increase in the antioxidant in the non-reaction region are small in Examples 1 and 2 compared to the Comparative Example. Therefore, according to the Examples, it is possible to lower the outflow amount and outflow possibility of the antioxidant within the electrolyte membrane.

As Examples of the present disclosure have been described in detail above, the right scope of the present disclosure is not limited to the above-described Examples, and various modifications and improved forms by those skilled in the art using the basic concept of the present disclosure as defined in the following claims are also included in the right scope of the present disclosure.

1. A membrane-electrode assembly comprising:
an anode layer;
a cathode layer; and
an electrolyte membrane interposed between the anode layer and the cathode layer, the electrolyte membrane having a sheet shape;
wherein the electrolyte membrane comprises:
an antioxidant;
the electrolyte membrane comprises: a reaction region in which the anode layer and the cathode layer are stacked and located in a central part of the electrolyte membrane; and a non-reaction region that is a rest part except for the reaction region; and
wherein the non-reaction region comprises a depression part depressed by a predetermined depth in a thickness direction from at least one surface of the electrolyte membrane.

2. The membrane-electrode assembly of claim 1, wherein the antioxidant comprises ions of a metal element, and the metal element comprises at least one of cerium, manganese, tungsten, zirconium, titanium, vanadium, yttrium, lanthanum, neodymium, nickel, cobalt, chromium, molybdenum, iron, or any combination thereof.

3. The membrane-electrode assembly of claim 1, wherein the depression part is depressed in the non-reaction region along a pair of opposite sides of the reaction region.

4. The membrane-electrode assembly of claim 3, wherein the reaction region comprises a pair of long sides and a pair of short sides, and the pair of opposite sides comprises at least one of the pair of long sides and the pair of short sides.

5. The membrane-electrode assembly of claim 1, wherein a depth of the depression part is deepened in a stepwise manner extending away from a side end portion of the reaction region.

6. The membrane-electrode assembly of claim 1, wherein a depth of the depression part is inclinedly deepened as it extends away from a side end portion of the reaction region.

7. The membrane-electrode assembly of claim 1, wherein a concentration of the antioxidant per unit volume of the non-reaction region increases as it extends away from a side end portion of the reaction region.

8. The membrane-electrode assembly of claim 1, wherein a depth of the depression part is 10% to 80% of a thickness of the reaction region.

9. The membrane-electrode assembly of claim 1, wherein the non-reaction region comprises a non-depression part formed at an end of the non-reaction region not to be depressed.

10. The membrane-electrode assembly of claim 1, wherein the membrane-electrode assembly further comprises a blocking part which is accommodated in the depression part and comprises a proton donor polymer.

11. The membrane-electrode assembly of claim 10, wherein the proton donor polymer comprises at least one of poly(acrylic acid), poly(methacrylic acid), modified polyphenylene oxide or any combination thereof.

12. The membrane-electrode assembly of claim 10, wherein a thickness of the blocking part is thickened as it extends away from a side end portion of the reaction region.

13. The membrane-electrode assembly of claim 10, wherein the blocking part is accommodated in the depression part so that there is no step difference between the reaction region and the non-reaction region.
